(19) United States
(12) Patent Application Publication
(10) Pub. No.: US 2026/0120469 A1
(43) Pub. Date: Apr. 30, 2026

(54) INTELLIGENT MANAGEMENT OF APPROACH BOUNDARIES IN INDUSTRIAL DOMAINS

(71) Applicant: Schneider Electric USA, Inc., Andover, MA (US)

(72) Inventor: Alen Mehmedagic, Wilmington, MA (US)

(73) Assignee: Schneider Electric USA, Inc., Boston, MA (US)

(21) Appl. No.: 19/003,760

(22) Filed: Dec. 27, 2024

Related U.S. Application Data
(60) Provisional application No. 63/615,661, filed on Dec. 28, 2023.

(51) Int. Cl. G06V 20/52; G06T 19/00; G06V 20/20; G06V 20/40; G06V 40/16; G06V 40/20

(52) U.S. Cl. CPC G06V 20/52; G06T 19/006; G06V 20/20; G06V 20/44; G06V 40/172; G06V 40/25; G06V 2201/07

(57) ABSTRACT

A method is disclosed, including determining a configuration of boundary(s) associated with one or more danger zones in the vicinity of industrial equipment, causing projection of visual markers on surfaces, the visual markers being configured based on the configuration of the respective boundary(s), processing images captured of the visual markers to detect a boundary event related to the visual markers, the boundary event including the presence of an intruder that is a person or an object proximate to, crossing over, moving to, or moving from the visual markers, determining whether the boundary event is allowed, processing the captured images and/or captured audio to determine or infer a location of the intruder before, during, or after the boundary event, selecting, contingent on a determination that the boundary event is not allowed, automated action(s) based on the location of the intruder, and causing performance of the automated action{s}.

### CROSS-REFERENCE TO RELATED APPLICATION

The present application claims the benefit of U.S. Provisional Patent Application Ser. No. 63/615,661, filed Dec. 28, 2023, entitled INTELLIGENT MANAGEMENT OF APPROACH BOUNDARIES IN INDUSTRIAL DOMAINS, which is incorporated herein by reference in its entirety.

### FIELD

This disclosure relates generally to safety management in industrial domains, and more particularly, to systems and methods relating to intelligent management of approach boundaries in industrial domains.

### BACKGROUND

As is known, an industrial operation, system, or plant typically includes a plurality of industrial equipment. The environment in which the industrial operation, system, or plant is physically situated is referred to as the industrial domain. Electrical installations in industrial domains can generate arc flashes, which are dangerous events when electric current, instead of following its intended path, and arcs through the air until making contact with another conductor or the ground. An arc flash can result, for example, in dangerous incidents, such as an explosion, fire, or electrocution that can cause serious injuries or death.

To lower the risk of arc flash injuries, such as during servicing, installation, and decommissioning of electrical installations in industrial domains, the Occupational Safety and Health Administration® of the United States Department of Labor has developed a set of approach boundaries, with requirements for different personal types of protective equipment (PPE) upon crossing each of these boundaries.

These approach boundaries are mainly physical boundaries, with little or no intelligent monitoring or enforcement. Safety is promoted by continuous training of personnel and engraving a code of responsibility on the personnel. However, training can be fleeting. Lack of enforcement can lead to dangerous incidents.

In other scenarios, danger zones related to a hazardous condition, event, or source of danger can be dynamic. A person or object may be unaware of the danger or uncertain how to escape from the danger. Even once aware, the person or object may be unable to ascertain dynamic danger zones and/or escape routes in real time, and therefore may be unable to avoid the danger zones or escape to a safe zone.

While conventional methods and systems have generally been considered satisfactory for their intended purpose, there is still a need in the art for systems and methods for intelligent reinforcement of electrical safety rules and detection of violations in real time, with corrective measures that also serve as deterrents, with the objective reducing arc flash related incidents in industrial domains. In addition, there is a still a need in the art for systems and methods for providing warnings about a dynamic danger zone and/or help the person or object find an escape routes from the dynamic danger zone.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a computer-implemented method performed for management of one or more danger zones for industrial equipment. The method includes determining a configuration of one or more boundaries associated with the one or more danger zones in the vicinity of the industrial equipment, causing projection of visual markers on surfaces, wherein the visual markers are configured based on the configuration of the respective one or more boundaries. The further includes processing images captured of the visual markers to detect a boundary event related to the visual markers, the boundary event including the presence of an intruder that is a person or an object proximate to, crossing over, moving to, or moving from the visual markers, determining whether the boundary event is allowed, processing the captured images and/or captured audio to determine or infer a location of the intruder before, during, or after the boundary event, selecting, contingent on a determination that the boundary event is not allowed, one or more automated actions based on the location of the intruder, and causing performance of the one or more automated actions.

In one or more embodiments, the one or more boundaries can be automatically determined using rules defined for the industrial equipment.

In one or more embodiments, processing the captured images can include applying video recognition and/or audio recognition to the captured video and/or audio to recognize an aspect of the intruder, wherein the one or more automated actions can be further selected based on the aspect of the intruder.

In one or more embodiments, recognizing the aspect of the intruder can include one or more of: determining, using a machine learning trained model that was trained to recognize different types of PPE worn by a person in motion, whether the intruder is wearing a type of PPE required for the boundary involved in the boundary event, and the determination whether the boundary event is allowed can be based on the determination whether the intruder is wearing the type of PPE; determining, using a machine learning trained model that was trained to recognize different types of undesired behavior and/or undesired equipment being or carried, whether the intruder exhibits undesired behavior and/or is wearing or carrying undesired equipment, and the determination whether the boundary event is allowed can be based on the determination whether the intruder exhibits the undesired behavior and/or is wearing or carrying the undesired equipment; and determining, using a machine learning trained model that was trained to recognize different types of uniforms used by special personnel, whether the intruder is wearing a uniform used by special personnel, and the determination whether the boundary event is allowed can be based on the determination whether the intruder is wearing the uniform used by special personnel.

In one or more embodiments, determining or inferring a location of the intruder can include one or more of transposing the captured audio into text and or producing a textual description of the captured images and analyzing the text to determine or infer the location of the intruder.

In one or more embodiments, processing the captured images to detect the boundary event can include applying vision detection, including detecting the visual markers and the intruder in the captured images and using locations in the image of the detected visual markers and the detected intruder.

In one or more embodiments, the one or more boundaries can include a plurality of boundaries, the respective boundaries having different associated restrictions, and the actions can be further selected based on which of the one or more boundaries was involved in the boundary event.

In one or more embodiments, the location of the intruder can be tracked and the one or more automated actions can include at least one of: providing a visual and/or audible warning based on the tracked location of the intruder; providing a directional visual and/or audible warning directed to the intruder at the tracked location of the intruder; providing via a networked device associated with the intruder or the industrial equipment a warning about the boundary event; causing removal of or reduction of power to, or adjusting one or more parameters associated with industrial equipment; causing removal or reduction of power to the industrial equipment depending on the location of the intruder; adjusting one or more parameters associated with industrial equipment or another source of danger depending on the location of the intruder; logging the breach event and its location in at least one database; further processing the captured images to determine whether the intruder has a mandated type of personal protective equipment (PPE) required for the boundary involved in the boundary event; further processing the captured images to determine whether the intruder has authorization required for causing the boundary event; deterring an intruder, using the location of the intruder, that exhibits a type of undesired behavior and/or is carrying or wearing undesired equipment; selecting protection devices based on the location of the intruder and controlling the protection devices; and determining and providing visual markers to mark an exit route to exit a vicinity of a danger event detected in the captured images.

In one or more embodiments, the captured images can include using facial recognition to determine an identity of the intruder, and determining whether the boundary event is allowed can include determining authorization of the identified intruder to approach or cross the boundary involved in the boundary event.

In one or more embodiments, the visual markers can be geometric shapes or images projected by a projector of a laser or other lights.

In one or more embodiments, determining the boundaries can include determining dynamically a configuration of the one or more boundaries, wherein the visual markers can be projected based on the dynamically determined configuration.

In one or more embodiments, processing the captured images and/or processing captured audio can include monitoring the captured images and/or the captured audio for a danger event, and the method can further include revising the one or more boundaries based on detection of the danger event.

In one or more embodiments, revising the boundaries can include determining an exit route to exit a vicinity of the danger event and providing visual markers to mark the exit route.

In one or more embodiments, the method can further include capturing the images.

In one or more embodiments, the method can further include projecting the visual markers.

In accordance with another aspect of the disclosure, disclosed is a system for management of one or more danger zones for industrial equipment. The system includes a memory configured to store a plurality of programmable instructions and a processor disposed in communication with the memory. The at least one processor upon execution of the program instructions is configured to perform the disclosed method.

In accordance with a further aspect of the disclosure, a method for management of one or more danger zones for industrial equipment is provided. The method includes processing captured images and/or captured audio at least to recognize a dangerous event using one or more trained machine learning models, predicting locations of the dangerous event based on the processed captured images and/or audio using the one or more trained machine learning models, causing projection of visual markers on surfaces and configured based on the predicted locations, and causing output of directional video and/or audio aid as an exit guide to a safe zone.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

The foregoing features of the disclosure, as well as the disclosure itself may be more fully understood from the following detailed description of the drawings, in which:

FIG. 1 shows an example management system for providing intelligent management of a danger zone in a first example scenario, in accordance with embodiments of the disclosure;

FIG. 2 shows the management system for providing intelligent management of a danger zone in a second example scenario, in accordance with embodiments of the disclosure;

FIG. 3A shows a flowchart illustrating an example method for management of one or more danger zones for industrial equipment in accordance with embodiments of the disclosure;

FIG. 3B shows a flowchart illustrating another example method for management of one or more danger zones for industrial equipment in accordance with embodiments of the disclosure;

FIG. 4 is a block diagram of an exemplary computing system that could be used for implementing a method for management of one or more danger zones for industrial equipment in accordance with embodiments of the disclosure.

### DETAILED DESCRIPTION

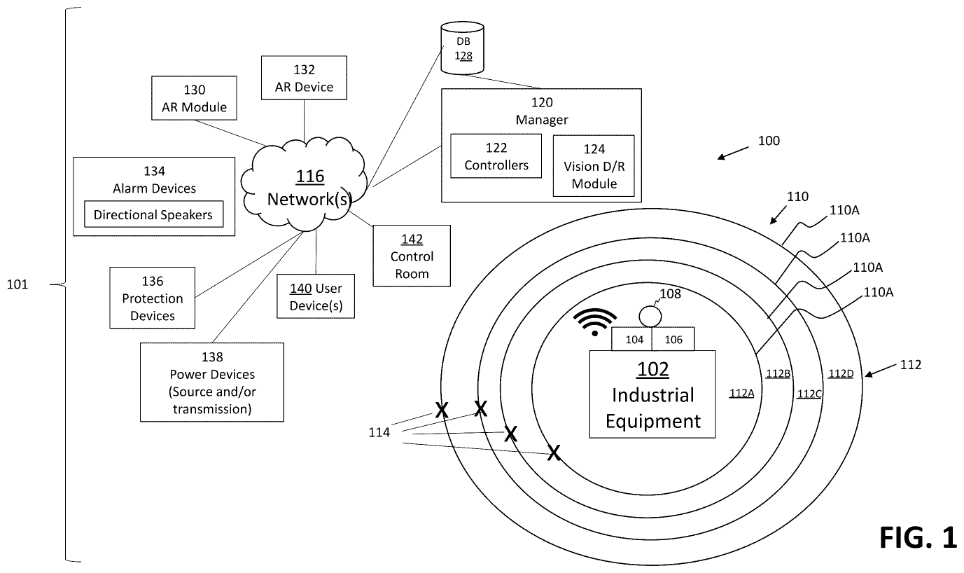

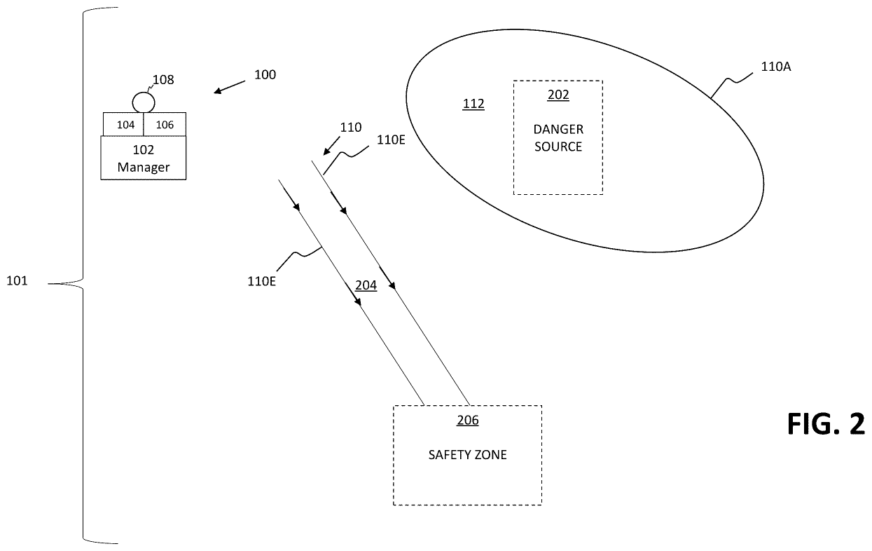

Reference will now be made to the drawings wherein like reference numerals identify similar structural features or aspects of the subject disclosure. For purposes of explanation and illustration, and not limitation, a block diagram of an exemplary embodiment of a sustainability optimization system in accordance with the disclosure is shown in FIG. 1 and is designated generally by reference character 100. Other embodiments of the sustainability optimization 100 in accordance with the disclosure, or aspects thereof, are provided in FIGS. 2-4, as will be described.

It is understood that the disclosure may be found suitable for use in numerous applications. The applications may include, for example, equipment in industrial installations related to production, manufacturing, refinement, distribution, management, etc. of oil, gas, electrical energy, nuclear energy, food and beverages, water, wastewater, chemicals, petrochemicals, pharmaceuticals, and mining of metals, minerals, etc. The applications can also apply to residential settings; community settings; and commercial settings.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a,” “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a disc, a memory storage device, or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

As used herein, the term “Machine Learning (ML)” is used to refer to the use and development of software that is able to learn and adapt without following explicit instructions, by using algorithms and statistical models to analyze and draw inferences from patterns in data.

As used herein, the term “video recognition” refers to image and video processing using machine learning to interpret and understand images or videos, including identifying and classifying elements captured in the images and videos for the purpose of extracting meaningful information. The output can be in a structured form that is available for analysis and decision making.

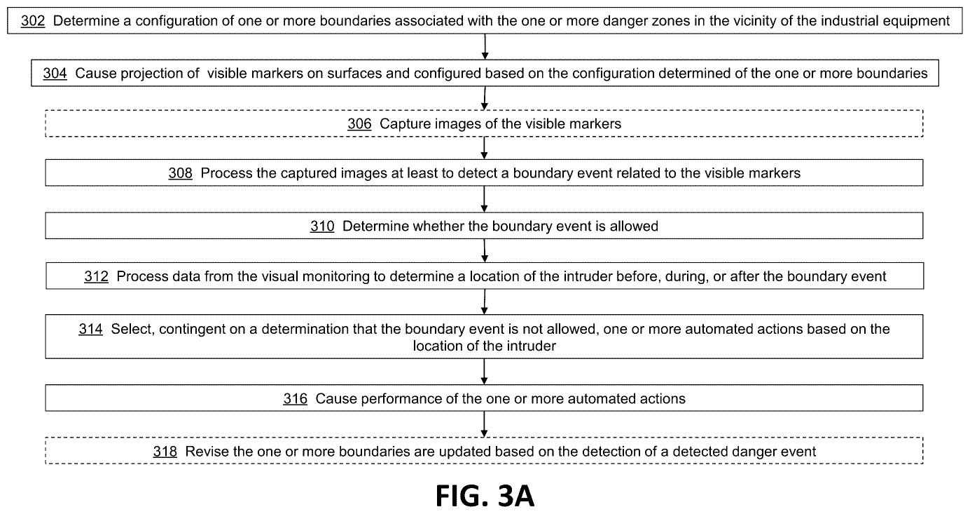

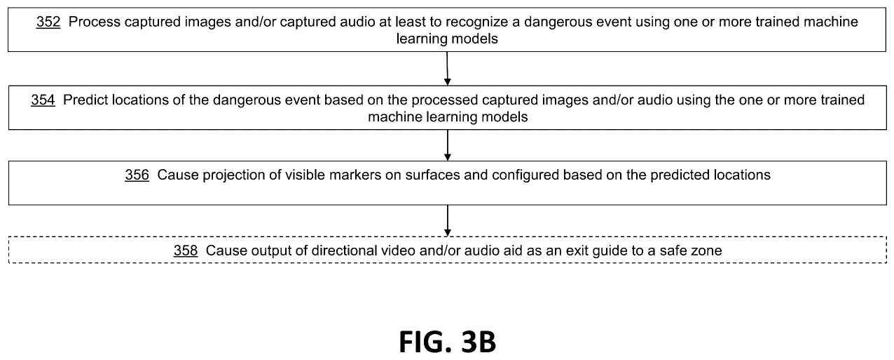

Referring to FIGS. 1 and 2, an example management system 100 in accordance with embodiments of the disclosure includes a manager 120, an image capture device 104, a sound system 106, and a projector or laser 108 (also referred to as projector/laser 108). Management system 100 monitors visual information in an environment of a source of danger (shown as industrial equipment 102 in FIG. 1 and danger source 202 in FIG. 2) using an image capture device 104. In addition, in certain embodiments, a sound system 106 can be used to monitor audible information in the environment of the source of danger. Manager 120 includes a computing system, such as shown in FIG. 3, that can further monitor the environment by processing image data captured by image capture device 104 and optionally audio data captured by sound system 106. The computing system can be actual or virtual. Manager 120 can further include or be coupled to controllers 122, such as based on output from image capture device 104 and microphones of sound system 106. Controllers 122 can control action components to perform actions in accordance with decisions made by manager 120. Action components can include, for example, image capture device 104 and sound system 106 to gather more data; projector/laser 108 and/or augmented reality (AR) module 130 and AR device 132 to indicate an escape route (e.g., escape route 110E shown in FIG. 2), alarms devices 134, protection devices 136, power devices 138, user devices 140, a control room 142, etc.

Manager 120, image capture device 104, sound system 106, and projector/laser 108 can each be standalone devices or can be integrated with one another into one or more devices in any combination. Manager 120 can communicate with image capture device 104, sound system 106, and projector/laser 108 via wired or wireless communication for providing control and/or processing the output data. Manager 120, image capture device 104, sound system 106, and/or projector/laser 108, whether standalone or integrated, can be portable devices that can be placed and optionally mounted in a strategic location, or can permanently mounted in a strategic location. Portions of processing described as being performed by manager 120 can be performed instead by any of image capture device 104, sound system 106, and/or projector/laser 108.

Manager 120 can identify one or more danger zones 112. In one or more embodiments, the danger zone(s) 112 can be identified based on extrinsic information about the source of danger, conditions in the environment, and/or by processing image data and/or audio data captured by image capture device 104 and/or sound system 106. Extrinsic information can include, for example, information about an associated danger and/or safety, regulatory, or proprietary requirements (e.g., donning of articular PPE, human presence not allowed, etc.) based on distance from equipment 102. Conditions in the environment can include sensed temperature, presence of a chemical, presence, or radiation, etc. Captured image and/or audio data can detect incident related phenomena, such as recognition in captured images of a spill, fire, smoke, etc., or recognition in captured sound of an alarm (fire, smoke, etc.), human call for help, gunshot, etc. Manager 120 can add and/or dynamically change danger zones 112 when an incident is detected.

In certain embodiments, safety zones (see safety zones 204 in FIG. 2), which can include exit (e.g., rescue or escape) routes (see escape route 206 in FIG. 2) to escape from danger zones can be identified based on information (similar to detecting danger zones) such as extrinsic information about the source of danger and/or environment (e.g., a map or floorplan), conditions in the environment, and/or by processing image data and/or audio data captured by image capture device 104 and/or sound system 106.

Approach boundaries 110A and escape boundaries 110E are referred to generally as boundaries 110. Manager 120 can control projector/laser 108 to project visual markers on surfaces, wherein the visual markers are positioned based on locations of the identified boundaries 110. In this way, management system 100 can automatically identify, configure, and mark the approach boundaries 110A.

Additionally or alternatively, manager 120 can control an augmented reality (AR) module 130 to display boundaries 110 as AR projections that can be seen using an AR device 132, such as glasses worn by a user or the user's mobile device.

Boundaries 110 can be configured, for example, as a circle, rectangle, square, or other shape. The dimensions of the shape can be determined by manager 120 in order to describe the corresponding danger zone 112. The dimensions of the shape can further be determined based on the environment of industrial equipment 102, such as to accommodate obstacles. For example, the circle can have a radius that equals a particular distance from industrial equipment 102 and describes a danger zone for that distance.

In one or more embodiments, manager 120 includes image processing and rule based capabilities. The image processing can include, for example, removing noise from an image, isolating dominant color regions, detecting and isolating edges, determining features/objects, removing unrelated objects, zooming in on a related object, repeating the process of refinement, generating a list of objects and relations between objects, feeding the list for further processing, such as rule-based analysis or analysis using ML, such as by a generic or specially trained model or LLM.

In one or more embodiments, manager 120 includes an intelligent vision detection/recognition (D/R) module 124 configured to perform image processing and video recognition using machine learning techniques, intelligent vision detection analysis, and intelligent vision recognition analysis related to a change in the environment that can indicate an intrusion by an intruder (e.g., a person or an object) of one or more of the danger zones 112 or the occurrence of an event. Using intelligent vision detection and/or recognition, manager 120 can thus monitor boundaries 110 to detect an actual or potential occurrence of an intrusion or an event relative to boundaries 110, e.g., proximate to, located at, or crossed over any of the respective boundaries 110. The monitoring can include tracking the person or object to determine whether this person or object is stationary, 0, is moving toward the boundary 110, or is moving away from the boundary.

Manager 120 can use one or more machine learning models. One or more of these models can be large language models (LLM) and/or use generative AI. The model(s) used can be proprietary or commercially available, such as ChatGPT®, Claude®, Gemini®, Copilot®. The model(s) can be honed for use in the industrial domain. The model(s) can be trained for specific tasks or can be generic. Prompts to a generative AI model can be determined from output of analysis performed using an LLM or a rule-based analysis.

Manager 120 can detect when a projected light beam (LED or laser) is disturbed by an intruder or event using one or more methods. This can include detecting which approach boundary 110A was breached. A processing determination can then determine which danger zone 112 corresponds to the approach boundary 110A that was breached.

One method includes detecting via image processing and/or video recognition that the light beam was interfered with (was blocked, deflected, reflected, absorbed, passed through a different medium, etc.) at a particular location, e.g., within the image of the light beam.

Another method includes detecting and recognizing that there is an intruder or a source of danger in the image and determining the location of the intruder or source of danger within the image or an actual location of the intruder or source of danger. This method can further include detecting boundaries 110 and their location, e.g., in the image. The location within the image of the intruder, source of danger, and boundaries 110 can be translated to their actual location. Manager 120 can use the location of the boundaries for determining the location of the intruder or source of danger.

The actual location can be a relative location that is relative to a reference point (e.g., image capture device 104, boundary 110, industrial equipment 102, center (or designated corner, etc.) of a room or area in which the industrial equipment 102 is located, etc.) or an absolute location (e.g., geolocation).

The location of the intruder and/or source of danger can be dynamic. The location of the intruder can be tracked and/or predicted using image processing and/or video recognition. The location of the source of danger can be fixed, such when the source of danger is industrial equipment 102 that is fixed at its location. When the location of the source of danger is dynamic (e.g., a fire, smoke, a spill, a chemical or radioactive leak, the changing location can be tracked using image processing and/or predicted.

Additionally or alternatively, audio data can be captured and analyzed to detect and recognize an intruder's intention of breaching a boundary. Manager 120 can process the captured audio data (e.g., using microphones of sound system 106 using a large language model (LLM). The analysis can optionally include transposing the captured audio data into text.

The LLM can use statements made by the intruder or others to infer the intruder's past, present, or future location. For example, the LLM can recognize statements made by an intruder that indicate an intent to breach a boundary 110, such as intent to enter or perform an act that would not be allowed based on the intruder's authorization and/or PPE currently worn.

For example, the intruder may make statement that indicates intent to open an electrical cabinet of industrial equipment 102 while the intruder is located is in a level one danger zone 112 wearing level one PPE. However, access to the electrical cabinet of industrial equipment 102 would require a much higher level PPE. In response, manager 102 may cause an action that includes communicating a warning to the intruder that adequate equipment needs to be worn before access to the electrical cabinet or approach to another boundary 110 is attempted. Manager 102 can take preemptive actions based on a combination of recognition of the intruder's intent in combination with a predicted trajectory based on tracking the intruder's location using the image processing and/or video recognition. The preemptive action can prevent or deter such access to unpermitted boundaries 110.

The model(s) (LLM and/or trained model) for recognizing an intruder's intention can be a generic LLM. In one or more embodiments, the LLM can be an LLM that is trained to detect words of intent, which can further optionally include training based on the specific context of industrial equipment 102.

In one or more embodiments, manager 120 can use a combination of vision detection and an LLM that produces a textual description of the captured images. This description can serve as input to a trained model, which in turn can determine or infer a location of the intruder in the past, present or future.

For example, the LLM can recognize relevant information in the captured images related to an actual or potential nonallowed breach of boundaries 112. A trained model can recognize when the description is related to an actual or potential breach of boundaries 112. The model can be trained using training data that includes, for example, descriptions of various images that indicate actual or potential nonconformance with safety requirements for different boundaries or indicate conformance with the safety requirements. Additionally, the description can indicate a location of an intruder relative to actual boundaries at the time.

The model(s) (the LLM and trained model) can be generic or can be trained to generate the description of the images in accordance with the context of potential nonconformance of an intruder in the images with requirements associated with boundaries in the images. The training can be based on the specific context of industrial equipment 102.

Manager 120 takes one or more actions in response to detection of a potential or actual intrusion by an intruder (a person or object) or an event. Some examples of actions include controlling alarm devices 134 to provide a visual and/or audio warning; controlling alarm devices 134 to provide an individualized or directional visual or audio warning directed to the intruder or to provide an exit or escape route 204 (shown in FIG. 2); controlling projector/laser 108 to provide visual markers to provide an exit route to a safe zone; providing a visual, audio, or tactile warning via a selected networked device 140 (e.g., of a selected person, such as the intruder or a supervising technician, or of a control room 142 for the industrial equipment 102; causing removal or reduction of power to industrial equipment 102, object intruder (e.g., robot or vehicle) or another source of danger; adjusting one or more parameters associated with industrial equipment 102 or another source of danger; logging an actual or attempted intrusion or an event in at least one database (DB) 128; performing detection and recognition analysis about the intruder or event, e.g., such as determining if the intruder has a mandated type of personal protective equipment (PPE) and/or authorization required for breaching a particular approach boundary 110A; performing detection and recognition analysis about the intruder or event, e.g., such as determining if the intruder exhibits a type of undesired behavior and/or is carrying or wearing undesired equipment, and controlling protection devices 136 to provide protection. Controllers 122 can control one or more of the actions.

The location of the intruder or source of danger can be used for controlling the actions. For example, the location of the intruder or source of danger can be used to controlling alarm devices 134 to provide a visual and/or audio warning in the location of the intruder or source of danger; controlling alarm devices 134 to provide a directional visual and/or audio warning directed to the location of the intruder, which can include to provide an exit or escape route 204 (shown in FIG. 2) that provides a guide to a safe zone (e.g., taking into account other environmental factors, as well as dynamics of the location of the source of danger as it changes over time); controlling projector/laser 108 to provide visual markers to provide an exit route to a safe zone relative to the (dynamic) location of the source of the danger (and other environmental factors); providing a visual, audio, or tactile warning or alert about the intrusion via a selected networked device 140 (e.g., of a selected person, such as the intruder or a supervising technician, or of a control room 142 for the industrial equipment 102; causing removal or reduction of power to industrial equipment 102 depending on the location of the intruder, such as only if the intruder has breached a particular boundary that is considered to be critical; adjusting one or more parameters associated with industrial equipment 102 or another source of danger depending on the location of the intruder, such as changing the parameter in increments as the intruder's location indicates that the intruder is coming closer to industrial equipment 102; logging the location of an actual or attempted intrusion or an event in at least one database (DB) 128; performing detection and recognition analysis about the intruder or event, e.g., such as determining if the intruder has a mandated type of PPE and/or authorization required for breaching a particular approach boundary 110A, wherein the type of PPE mandated depends on which boundary has been crossed; deterring an intruder (using their location) that exhibits a type of undesired behavior and/or is carrying or wearing undesired equipment and needs to be deterred; and controlling protection devices 136 selected based on their location relative to the tracked location of the intruder or the dynamic location of the source of danger to provide protection.

The danger zones 112 can be dynamic and the location of the intruder can be dynamic, manager 120 and manager 120 can track either or both of these. Further, manager 120 can decide to cause an action based on the tracked location of the intruder relative to the tracked position of danger zones 112.

FIG. 1 shows a first example scenario in which one or more boundaries are determined for an apparatus that is industrial equipment 102. The industrial equipment 102 is included in an industrial installation in an industrial domain, meaning the environment of an industrial operation, system, or plant. Industrial equipment can include, for example, electrical equipment that can be a source of danger because it is a type of equipment that can generate dangerous arc flashes capable of causing, for example, explosions, fires, electrocution. Other examples of industrial equipment 102 include industrial (or commercial or residential) robots, industrial production equipment, industrial used for production, manufacturing, refinement, distribution, management, etc. of oil, gas, electrical energy, nuclear energy, food and beverages, water, wastewater, chemicals, petrochemicals, pharmaceuticals, and mining of metals, minerals, etc.

In this example, electrical installments that are at risk of causing arc flashes are regulated by regulatory bodies, such as the Occupational Safety and Health Administration® (OSHA®) of the United States Department of Labor. OSHA can specify, for example, a range of radii from electrical equipment that define different danger zones 112, and can mandate particular precautions to take at each of the danger zones, such as no entry (e.g., danger zone 112A), entry only allowed with extremely protective PPE (e.g., danger zone 112B), entry only allowed with mediumly protective PPE (e.g., danger zone 112C), entry only allowed with lightly protective PPE (e.g., danger zone 112D).

Manager 120 defines a boundary 110 for each of the danger zones 112. Each of the one or more boundaries 110 can be an approach boundary 110A. Locations of the one or more approach boundaries 110A and the associated danger zones 112 are relative to a physical location of industrial equipment 102. The approach boundaries 110A can be defined by safety guidelines, e.g., set by OSHA, for the at least one industrial (industrial) installation. The safety guidelines can specify rules for approaching each of these approach boundaries 110A.

Manager 120 can consult a data structure (e.g., a table, which can be stored, for example, in database (DB) 128). Database 128 is accessible to or is included in manager 120. The data structure stores rules specified by the safety guidelines for establishing one or more danger zones 112 established for the particular industrial equipment 102. The rules can further specify requirements associated with each of the one or more danger zones 112.

Manager 120 determines the danger zones 112 and associated approach boundaries 110A based on the rules provided in the data structure. Manager 120 controls laser/projector 108 and/or AR module 130 to project actual (or virtual for embodiments using AR) visual markers on actual (or virtual for embodiments using AR) surfaces in the environment around industrial equipment 102 based on the locations determined for the approach boundaries 110A.

Laser/projector 108 can include one or more light sources configured as one or more arrays of light sources, a rotating light source (or array of light sources), or a light source and rotating mirrors to reflect a light beam from the light source. The one or more light sources are controlled to project visual markers in different directions to define one or more visual boundaries 110 in accordance with dimensions of the corresponding boundaries they are defining. Particular light sources of the array can be selected and activated to project the visual markers, and/or the rotation can be used to project the visual markers. An aiming device can be controlled to orient and aim the light source(s) to draw the visual markers appropriately in accordance with dimensions of the boundaries they are defining. Laser/projector 108 can be positioned in a location from which it is capable of projecting the visual markers, such as by placing or mounting laser/projector 108 on the industrial equipment 102 itself or on another structure. Some commercially available projectors include LightScene® EV-115 Accent Lighting 3LCD Laser Projector by Epson®, ECO Spot D25 Gobo Projector with Rotator by Custom Gobo Source Projection Systems®, 5w Full color phantom laser light-A10 by TheLaserLight™.

The projected visual markers are light or lasers that are visible to a person or object in the vicinity. The visual markers serve as a warning to persons or objects approaching industrial equipment 102, raising awareness of the danger zones 112 and providing a reminder of the requirements for using PPE or not entering the respective danger zones 112.

Image capturing device 104 can include an array of sensors or one or more (arrays of) rotating sensors that can capture images of any accessible area that surrounds industrial equipment 102. The image capturing device 104 captures images and manager 120 processes image data in the captured images to detect when a person or object (also referred to as an intruder) is present in the vicinity, such as when the object or person is proximate to, crossing over, moving toward, or moving away from the approach boundaries of the one or more danger zones. A determination of which sensors and the positions of the sensors that captured image data that corresponds to a person or object can be used to determine the position of and track the person or object.

The location of the breach can be used to image the intruder and/or track the intruder.

Recognition analysis can be performed, for example, to recognize whether PPE is worn by a person captured in images being analyzed and recognize a type of any PPE worn by the intruder. Additionally, processing can be performed to determine whether the type of the PPE recognized in the images satisfies the mandated PPE for the danger zone 112 defined by the particular approach boundary 110 that was breached.

The detection and recognition of whether PPE is being worn and recognition of the type of PPE being worn uses an ML model that is trained for this task. The detection and recognition can be performed on images that capture the PPE and/or intruder at different orientations (of the intruder and of the image capture device 104), the intruder and PPE can be of varying sizes and types, and the images can be captured from many different ranges between image capture device 104 and the intruder.

Manager 120 can use an ML trained model that was trained to detect and recognize different types of PPE. Manager 120 can further train the ML model to detect PPE using training data with and without PPE as worn by individuals of different sizes imaged with different orientations and from different distances using supervised or unsupervised learning. Manager 120 can further use the same or another ML model to recognize different types of PPE. Manager 120 can further train the ML model to recognize PPE using training data with different types of PPE and supervised or unsupervised learning. The training data can include images of different types of PPE being worn or not being worn, and will include images in which the PPE is imaged using different orientations and from different distances, use one or more neural networks to training and/or applying the ML model.

Manager 120 can use an ML trained model that was trained to detect and recognize different types of uniforms used by special personnel, such as police officers, fire fighters, emergency medical technicians, etc. The training data used to train the ML model can include different varieties of uniforms and/or insignia used by the special personnel, including from different orientations and positions of the person wearing the uniform as viewed from different orientations and/or distances.

The danger zones 112 and their boundaries 110 and/or corresponding requirements (e.g., PPE requirements) for the danger zones 112 and boundaries 110 can be redefined, such as to allow the special personnel a privilege to perform their role without exposing them to imminent danger. Additionally or alternatively, certain PPE requirements can be determined to be satisfied when a particular type of uniform is recognized. Additionally or alternatively, actions caused by manager 120 in response to a requirement not being met can be modified based on the uniform that is recognized. For example, manager 120 can adjust visual and/or audio warnings caused by manager 120 to be projected based on the type of uniform that is recognized. Such modifications can be made, for example, to allow police to physically secure a perimeter without entering an area in which an active danger (e.g., fire, chemical vapors) exists, while fire fighters or HAZMAT workers may enter with extinguishers to perform containment. As the containment is performed.

Manager 120 can further use results of image processing, video recognition, and/or feedback from one or more sensors to track an area (e.g. its perimeter) of a danger zone 112 and its boundaries 110 that developed due to an event (e.g., fire or chemical spill), such as to reduce the area as the danger is contained. This dynamic adjustment of the danger zone 112 can allow emergency personnel to enter and perform their tasks.

Additionally or alternatively, other detection tasks and recognition tasks can be performed using appropriately trained models. For example, in addition to detecting an intruder, face detection and recognition can be performed. Database 128 can include a database of facial data correlated to identities, which can further be correlated to levels of authorization for entering different danger zones 112.

Sound system 106 can include an array of microphones or one or more microphones that detect sound and capture sound data. The microphones can be disposed in different locations in the environment of industrial equipment 102. Sound system 106 can determine a direction from which the sound came, such as based on the respective positions and/or orientations of the particular microphones that captured the sound data at the time of capture and characteristics of the sound data (e.g., volume, clarity, etc.).

Manager 120 can further process the sound data to detect whether a person or object is present or approaching and a location of the detected person or object. A determination of which microphones and the respective positions and/or orientations of the particular microphones that captured sound data that corresponds to a person or object, and characteristics of the sound data can be used to determine the position of and track the person or object.

Manager 120 can further process the image data and/or the sound data to determine an identity of the person or object, such as by using face recognition or voice recognition. Manager 120 can use an ML trained model that was trained to identify persons or objects from the image or sound data. Manager 120 can further train the ML model. Manager 120 can use one or more neural networks to training and/or applying the ML model.

Once the identity of the person or object is determined, manager 120 can consult information about authorized personnel or objects stored in database 128 to determine if the identified person or object is authorized to breach a particular approach boundary 110A. Manager 120 can further process the image data and/or the sound data to detect changes in the environment of industrial equipment 102, such as the presence or development of any dangers. Alarm devices 134 can further include one or more speakers for emitting sound. The speakers can be directional speakers that harness principles of ultrasonic waves and/or employ advanced sound beaming techniques.

The directional speakers can include an array of one or more speakers that can be disposed at one or more different locations, such that certain speakers of the array can be activated to provide directionality. In certain embodiments the directional speakers can rotate or be dynamically oriented, such that the speakers can be rotated to project sound in a particular direction. Examples of commercially available directional speakers include Videotel Digital® VIDBeam Directional Sound Speaker by Videotel Inc. and directional speakers by Focusonics®.

Manager 120 can thus detect when a person or object is in a location or is heading to a location for which authorization is not provided and/or has violated a rule of the safety guidelines, such as by breaching, being located proximate to, or moving toward any of the approach boundaries 110A without having a type of PPE designated for a corresponding danger zone 112 or when otherwise not permitted. Manager 120 can send warnings when a violation is detected. The warnings alert the person or object of the danger or alert a remote operator that there is a rule violation. The warning can include information about the violation and what the person or object should do, such as to stop, don a particular type of PPE, or leave.

The warnings can include audible warnings delivered via speakers of alarm devices 134 can emit an audible warning. An audible warning can be a directional audible warning directed to the tracked location of the person or object. The audio warnings can include loud noises and/or bright lights (e.g., directed at the intruder) that are uncomfortable to the intruder. The warnings can be delivered via a communication network to a personal computing device (e.g., a mobile phone or smart device) known to belong to the person or object that was identified. The warnings can include visual and can be delivered via the displayed markers, such as by flashing, changing colors, or changing designs of the displayed markers. The visual warnings can include bright lights that are uncomfortable to the intruder. The bright lights can be directional and directed to the tracked location of the intruder. The visual warnings can be generated by the laser/projector 108 and/or by an additional projector.

The warnings (and/or other actions) caused by manager 120 can be modified based on undesired equipment detected by manager 120. For example, if a weapon is detected as being held or carried by the intruder (and a uniform identifying the intruder as being allowed to carry a weapon has not been detected) the warning can include directing a bright light or loud sound directly toward the person in a fashion to deter the person, such as by directing a debilitating laser light or audio sound.

When using AR, the visual warnings can be changed to alert the intruder and/or to cause the intruder to feel uncomfortable, such as by strongly displaying motion, contrast, textual messages, For example, two-dimensional or three-dimensional renderings of light can be generated to feel as if they are in front of the person as an obstacle to and/or a means to slow down the person's motion.

These types of warnings and types of delivery of the warnings are meant to be examples and are not intended to limit the disclosure.

In addition to or alternative to delivering warnings, manager 120 can take other actions when a violation (including the presence or movement of an unauthorized person or object) is detected. Each violation and/or action taken can be logged in database 128.

FIG. 2 shows a second example for application of management system 100 for monitoring a dynamic danger source 202 that can have one or more associated dynamic danger zones 112. The danger source 202 can be detected by manager 120. Manager 120 can monitor danger source 202 to determine the danger zone(s) 112 as they change and to determine one or more escape routes 204 for escaping from the danger zone(s) 112 and potentially arriving at a safety zone 206.

Manager 120 can detect and/or monitor the danger source 202 using image capture device 104 and/or sound system 106. Information from additional sensors can be used as well (smoke sensors, toxin sensor, etc.). Examples of danger sources 202, without limitation, include a fire, an active shooter, a chemical leak, a spill, etc.

Manager 120 can dynamically determine the escape route(s) 204 based on the danger zone(s) 112 as they change over time and other information available to manager 120, such as building plans of a building in which the danger zone(s) 112 are located.

Regarding the various embodiments, management system 100 provides intelligent management of industrial approach boundaries.

Management system 100 is equipped with a projector projecting images or an LED laser projector projecting outlines. Management system 100 integrates a high-definition camera for image processing, artificial intelligence (AI), and/or vison recognition software capable of detection and identification of projected boundaries. Management system 100 also has acoustic device, such as one or more speakers, to interact with the environment. Management system 100 is equipped with network connectivity for configuration and general communication.

A purpose of management system 100 is to establish boundaries for industrial safety. Other purposes include establishment of virtual boundaries of restricted spaces.

In an industrial safety application, management system 100 is provided with an industrial specification of electrical equipment, such as equipment that is under repair. For example, management system 100 can use OSHA tables 425B and can calculate and determine safe distances and proper PPE required for operation on electrical equipment of industrial equipment 102. Since management system 100 is equipped with a projector, it can “draw” (meaning to project visual markers) and project calculated boundaries on surrounding surfaces. Management system 100 can label the distance and the required PPE to enter the drawn area so that it is visible to a person viewing the vicinity. Such drawing (meaning projection of visual markers) can be used to install physical boundaries if required.

With use of single or multiple camera installations, management system 100 is capable of detecting disturbances to the boundaries. This is similar to, but different from, a laser beam motion detection system, because management system 100 uses intelligent image processing (using visual detection and recognition), which can include face recognition systems, to detect the disturbances. Detected disturbances to the projected image can be examined. Image processing and/or video recognition can be used to recognize when a detected object has a human form and extract details of a type of PPE used by the person and a level of the type of PPE used. Management system 100 can determine the level of PPE needed per position of the person relative to the areas drawn by the projected images or lasers and the associated boundaries, and determine if the PPE used by the person based on their current location and/or their tracked movement is, or is anticipated to, soon violate safety requirements.

Management system 100 can perform facial recognition of the subject person to unlock access to the industrial equipment 102 based on the person's level of authorization and the PPE used by the person being in compliance with the safety guidelines. Access may not be unlocked unless management system 100 is properly installed with relation of industrial equipment.

If a violation is detected (such as noncompliance with the safety guidelines or attempted access by an unauthorized person), management system 100 can flash the projected approach boundaries 110A and/or issue textual or audio warnings. Additionally, violations can be timestamped and logged with an indication of the location of the corresponding violation.

In certain embodiments, management system 100 is connected to a power control system of industrial equipment 102 and can cause the power control system to turn off, remove power, or reduce power of the industrial equipment 102 or the intruder (e.g., wherein the object is a robot or other mechanism) based on the level of violation and/or neglection to heed the warnings.

Management system 100 can be a networked system. For example, manager 120 can be coupled via network 116 to one or more devices or systems. Additionally or alternatively, management system 100 can be connected directly to such devices or systems. Manager 120 and/or one or more of the devices to which it is connected can be cloud-based.

Network 116 can include one or more networks, such as (without limitation) a local area network (LAN), a public or private wide area network (WAN), a virtual private network (VPN), a cellular network, a mesh network, etc.

Some nonlimiting examples of devices or systems which manager 120 is integrated with, coupled to, or directly connected to include a database 128, a control room 142, one or more programmable logical controllers (PLCs) (independently operating based on its own logic or connected to the control room and personnel mobile devices.

Remote control room 142 can be equipped with monitoring and/or control modules, such as one or more human machine interfaces (HMI) for monitoring and/or controlling industrial equipment 102. Image capture device 104 and/or sound system 106 and alarm devices 134 can provide or assist with live monitoring of the vicinity of industrial equipment 102 and enable interaction between the control room and personnel in the vicinity of industrial equipment 102.

Management system 100 can serve as an alarm in the event of an accident or emergency. Management system 100 can further provide a homing system for a rescue crew. Management system 100 can project dynamic boundaries and/or animations to guide personnel to or from the location of an incident associated with industrial equipment 102.

Management system 100 can be connected to one or more communication systems for providing communication with cell phones or networked devices of various local or remote personnel (e.g., plant personnel, operators, electricians, etc.) such as for providing automatic warnings or notifications about violations or incidents related to industrial equipment 102.

The concept can be adapted to and/or integrated with an AR application. The projected boundaries 110 can be overlayed on a physical location. Users of augmented reality tools, such as AR glasses, can visualize the boundaries without the need for active projection.

With AR, the projected boundaries can be enhanced by adding content.

Management system 100 can be used in connection with hazardous industrial equipment 102, as well as other hazardous equipment or substances present in various industrial industries such as biological, chemical, or mechanical hazards. In one or more embodiments, management system 100 ca by used in connection with commercial spaces, residential spaces, or communal spaces that present other hazards.

For example, a grocery store can project boundaries to warn customers of wet floor. The projected boundaries can be used to close particular aisles in a store or warehouse. In the case of an alarms (e.g., fire or active shooter) the alarm can be enhanced by dynamically projecting the boundaries to illuminate evacuation routes.

The projected boundaries 110 can be combined with physical, tangible boundaries (e.g., physical barriers) to provide customizable descriptive content. It can provide customizable and more descriptive deterrents. Thus, management system 100 can serve to enforce and/or enhance physical, tangible boundaries.

Dynamic physical boundaries (barriers embedded in the ground that can be controlled to move between above ground positions that provide a barrier and below ground positions that do not provide a barrier, motorized fences that can be moved to different positions, controllable locks that can be used to lock an entrance or exit path (e.g., on a gate or door)).

Management system 100 can direct sound emission by speakers of sound system 108 to cause a beam of sound to be directed to an individual person, providing an individualized deterrent, avoiding disturbance to others. Management system 100 can combine its capability to process captured images to determine a location of a violation of safety guidelines related to a particular boundary 110 and use the location determined to orient directional sound to that particular location, this minimizing disruption by warnings to unaffected areas.

With reference now to FIGS. 3A and 3B, shown are flowcharts demonstrating implementation of the various exemplary embodiments. It is noted that the order of operations shown in FIGS. 3A and 3B is not required, so in principle, the various operations may be performed out of the illustrated order. Also, certain operations may be skipped, different operations may be added or substituted, some operations may be performed in parallel instead of strictly sequentially, or selected operations or groups of operations may be performed in a separate application following the embodiments described herein.

FIGS. 3A and 3B show flowcharts of methods for management of one or more danger zones for industrial equipment, such as industrial equipment shown in FIG. 1. The method is performed by a management system, which includes a computing system, such as manager 120 shown in FIG. 1.

Beginning with FIG. 3A, at block 302, a configuration is determined of one or more boundaries associated with the one or more danger zones in the vicinity of the industrial equipment. The determination can be made automatically, e.g., based on rules, such as protocols or regulations associated with industrial equipment 102. The protocols or regulations can be defined by proprietary or governmental mandates, for example, for taking precautions at different danger zones. The precautions can depend, for example, on a distance from the industrial equipment.

The boundaries may be arbitrary or process related. Plant personal may have local rules for proximity to particular equipment which they can enter manually. Process or equipment related boundaries may be determined based on physical characteristics of the equipment (e.g., that can be determined via digital data sheets (DDSs) or obtained from the equipment via protocols such as OPCUA. For example, when the industrial equipment is robot, a rotational diameter of the robot's arm can be found in a digital user manual for the robot or can be obtained from network accessible data for the robot. This information can be augmented with a general safety policy to provide perimeter around the robot for which approach is safe. Breach of the perimeter may result in robots slow down or complete stop of operation.

The boundaries can also be related to a detected incident. The boundaries can be dynamic if the incident changes over time.

At block 304, projection of visual markers on surfaces (e.g., fixtures (e.g., floors, walls) or movable items (e.g., screens, furniture)) is caused. The visual markers are configured based on the configuration of the respective one or more boundaries.

The visual markers can be, for example, geometric shapes (circles, lines, squares, rectangles, irregular polygons) or images projected by a projector. The projector can use a light source or an array of light sources. The light sources can be, for example, a laser or LEDs. The projector can be fixed in position or can rotate. In one or more embodiments, the method can include projecting the visual markers, such as when the management system includes the projector. The projected visual markers can be provided via AR using an AR module.

At block 306, captured images of the visual markers are processed to detect a boundary event related to the visual markers. The boundary event includes the presence of an intruder, which is a person or an object, proximate to, crossing over, moving to, or moving from the one or more visual marker. In one or more embodiments, the method can also include capturing the images, such as when the management system includes one or more image capture devices.

In one or more embodiments, processing the captured images to detect the boundary event can include applying vision detection and/or vision recognition techniques, including, for example, detection of a person or object and/or detection of the visual markers.

The visual markers and the intruder can be detected in the images and compared, and comparing the detected visual markers and the detected intruder, to determine, for example, that a boundary that corresponds to the detected intruder was breached, is about to be breached, an intention to breach has been detected, etc.

At block 308, a determination is made whether the boundary event is allowed. This determination can use information obtained by vision recognition performed when processing the captured images.

In one or more embodiments, processing the captured images includes determining, using a machine learning trained model that was trained to recognize different types of PPE worn by a person in motion, whether the intruder is wearing a type of PPE required for the boundary involved in the boundary event, and the determination whether the boundary event is allowed is based on the determination whether the intruder is wearing the type of PPE.

In one or more embodiments, processing the captured images includes using facial recognition to determine an identity of the intruder, and determining whether the boundary event is allowed includes determining authorization of the identified intruder to approach or cross the boundary involved in the boundary event.

At block 310, data from the visual monitoring is processed to determine a location of the intruder before, during, or after the boundary event.

At block 312, contingent on a determination that the boundary event is not allowed, one or more automated actions are selected based on the location of the intruder. The automated actions can be determined using a rule-based algorithm, such as based on which boundary was breached and the egregiousness of the breach. An LLM can generate language-based textual or audio messages output, e.g., via an HMI of control room 138 or user device(s) 140.

At block 314, performance of the one or more automated actions is caused (e.g., using controllers and/or a control room, such as controllers 122 and control room 142 shown in FIG. 1).

In one or more embodiments, the one or more boundaries include a plurality of boundaries and the respective boundaries having different associated restrictions. The actions can be further selected based on which of the one or more boundaries was involved in the boundary event.

In one or more embodiments, processing the captured images includes recognizing an aspect of the intruder, wherein the one or more automated actions are further selected based on the aspect of the intruder. For example, the aspect of the intruder can be what type of PPE is worn by the intruder, identity of the user based on the user's image, etc.

In one or more embodiments, the location of the intruder is tracked and the one or more automated actions include at least one of: providing a visual and/or audible warning based on the tracked location of the intruder; providing (e.g., actually or using AR via an AR module) an individualized or directional visual and/or audible warning directed to the intruder at the tracked location of the intruder; providing via a networked device associated with the intruder or the industrial equipment a warning about the boundary event; causing removal of or reduction of power to, or adjusting one or more parameters associated with industrial equipment; logging the breach event and its location in at least one database; further processing the captured images to determine whether the intruder has a mandated type of PPE required for the boundary involved in the boundary event; further processing the captured images to determine whether the intruder has authorization required for causing the boundary event; selecting protection devices based on the location of the intruder and controlling the protection devices; and determining and providing visual markers to mark an exit route to exit a vicinity of a danger event detected in the captured images.

In one or more embodiments, processing the captured images and/or processing captured audio includes monitoring the captured images and/or the captured audio for a danger event, and the method further comprises revising the one or more boundaries based on detection of the danger event.

For example, a spill, fire, smoke, a person panicking, etc., can be recognized in the captured image. A gun shot, explosion, scream, unexpected shouting, etc., can be recognized in the captured audio. These can be correlated with one another or used individually as indicators of a danger event.

In one or more embodiments, revising the boundaries can include determining an exit route to exit a vicinity of the danger event and providing visual markers to mark the exit route.

With reference to FIG. 3B, in one or more embodiments, at block 352 captured images and/or captured audio are processed (e.g., using image processing and/or video recognition) to recognize a dangerous event. The processing can use a model trained to recognize dangerous events, such as by recognizing a spill, fire, smoke, a person panicking, etc., in an image and/or a gun shot, explosion, scream, unexpected shouting, etc., or a combination of features recognized in both the captured images and the captured audio.

In one or more embodiments, one or more LLM models can be used in combination with the video recognition, such as to transpose captured audio into text and/or to produce a description of captured images or video. The output can be analyzed by the trained video to recognize the dangerous event.

At block 354, locations of the dangerous event are predicted based on the processed captured images and using a trained machine learning model.

At block 356, projection of visual markers on surfaces and configured based on the predicted locations is caused.

In optional block 358, the method can further include causing output of individualized and/or directional video and/or audio aid as an exit guide to the safety zone. The directional video and/or audio aid can provide instructions to an individual via texts (e.g., to the individual's personal mobile device), projected images (e.g., signs, arrows, etc.), audio voice messages, warning sounds, etc.

In one or more embodiments, the method can include capturing the images and/or the audio, projecting the visual markers, and/or outputting the individualized or directional video and/or audio. The projected visual markers, directional video, and/or directional audio can be provided via AR using an AR module.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

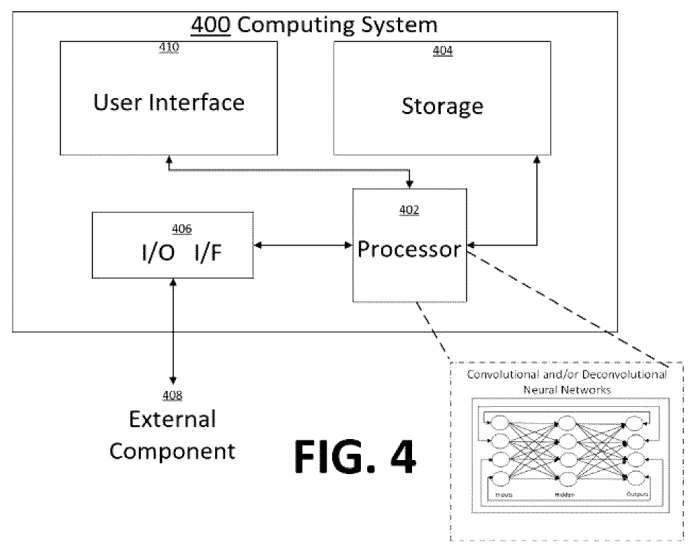

With reference to FIG. 4, a block diagram of an example computing system 400 is shown, which provides an example configuration of a computing system used by manager 120 of management system shown in FIG. 1. Additionally, all or portions of computing components of management system 100 could be configured as software, and computing system 400 could represent such portions. Computing system 400 is only one example of a suitable system and is not intended to suggest any limitation as to the scope of use or functionality of embodiments of the disclosure described herein. Computing system 400 can be implemented using hardware, software, and/or firmware. Regardless, computing system 400 is capable of being implemented and/or performing functionality as set forth in the disclosure.

Computing system 400 is shown in the form of a general-purpose computing device. Computing system 400 includes a processing device 402, memory 404, an input/output (I/O) interface (I/F) 406 that can communicate with an internal component, such as a user interface 410, and optionally an external component 408, including for network connectivity.

In certain embodiments, processing device 402 can include, for example, a PLOD, microprocessor, DSP, a microcontroller, a field programmable gate array (FPGA), an application specific integrated circuit (ASIC), and/or other discrete or integrated logic circuitry having similar processing capabilities.

In certain embodiments, processing device 402 and the memory 404 can be included in components provided in an FPGA, ASIC, microcontroller, or microprocessor, for example.

In embodiments, processing device 402 can include or access a neural network 412 (e.g., convolutional or deconvolutional neural networks).

Memory 404 can include, for example, volatile and non-volatile memory for storing data temporarily or long term, and for storing programmable instructions executable by the processing device 402. Memory 404 can be a removable (e.g., portable) memory for storage of program instructions. I/O I/F 406 can include an interface and/or conductors to couple to the one or more internal components 410 and/or external components 408.

Embodiments of the computing components of management system 100 may be implemented or executed by one or more computer systems, such as a microprocessor. Each computer system 400 can be included within the computing components of management system 100, or multiple instances thereof.

In certain embodiments, computer system 400 is embedded in a device, such as industrial equipment 102, image capture device 104, or projector/laser 108. Portions of the computer system 400 can be provided externally, such by way of an interface.

Computer system 400 is only one example of a suitable system and is not intended to suggest any limitation as to the scope of use or functionality of embodiments of the disclosure described herein. Regardless, computer system 400 is capable of being implemented to perform any of the functionality set forth hereinabove.

Computer system 400 may be described in the general context of execution of computer system-executable instructions, such as program modules. Generally, program modules may include routines, programs, objects, components, logic, data structures, and so on that perform particular tasks or implement particular abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and/or block diagrams in the Figures illustrate the architecture, functionality and/or operation of possible implementations of various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method for management of one or more danger zones for industrial equipment, wherein the method comprises:
determining a configuration of one or more boundaries associated with the one or more danger zones in the vicinity of the industrial equipment;
causing projection of visual markers on surfaces, the visual markers being configured based on the configuration of the respective one or more boundaries;
processing images captured of the visual markers to detect a boundary event related to the visual markers, the boundary event including the presence of an intruder that is a person or an object proximate to, crossing over, moving to, or moving from the visual markers;
determining whether the boundary event is allowed;
processing the captured images and/or captured audio to determine or infer a location of the intruder before, during, or after the boundary event;
selecting, contingent on a determination that the boundary event is not allowed, one or more automated actions based on the location of the intruder; and
causing performance of the one or more automated actions.

2. The computer-implemented method of claim 1, wherein the one or more boundaries are automatically determined using rules defined for the industrial equipment.

3. The computer-implemented method of claim 1, wherein processing the captured images includes applying video recognition and/or audio recognition to the captured video and/or audio to recognize an aspect of the intruder, wherein the one or more automated actions are further selected based on the aspect of the intruder.

4. The computer-implemented method of claim 3, wherein recognizing the aspect of the intruder includes one or more of:
determining, using a machine learning trained model that was trained to recognize different types of PPE worn by a person in motion, whether the intruder is wearing a type of PPE required for the boundary involved in the boundary event, and the determination whether the boundary event is allowed is based on the determination whether the intruder is wearing the type of PPE;
determining, using a machine learning trained model that was trained to recognize different types of undesired behavior and/or undesired equipment being or carried, whether the intruder exhibits undesired behavior and/or is wearing or carrying undesired equipment, and the determination whether the boundary event is allowed is based on the determination whether the intruder exhibits the undesired behavior and/or is wearing or carrying the undesired equipment; and
determining, using a machine learning trained model that was trained to recognize different types of uniforms used by special personnel, whether the intruder is wearing a uniform used by special personnel, and the determination whether the boundary event is allowed is based on the determination whether the intruder is wearing the uniform used by special personnel.

5. The computer-implemented method of claim 3, wherein determining or inferring a location of the intruder includes one or more of transposing the captured audio into text and or producing a textual description of the captured images and analyzing the text to determine or infer the location of the intruder.

6. The computer-implemented method of claim 1, wherein processing the captured images to detect the boundary event includes applying vision detection, comprising:
detecting the visual markers and the intruder in the captured images; and
using locations in the image of the detected visual markers and the detected intruder.

7. The computer-implemented method of claim 1, wherein the one or more boundaries include a plurality of boundaries, the respective boundaries having different associated restrictions, and the actions are further selected based on which of the one or more boundaries was involved in the boundary event.

8. The computer-implemented method of claim 1, wherein the location of the intruder is tracked and the one or more automated actions include at least one of: providing a visual and/or audible warning based on the tracked location of the intruder; providing a directional visual and/or audible warning directed to the intruder at the tracked location of the intruder; providing via a networked device associated with the intruder or the industrial equipment a warning about the boundary event; causing removal of or reduction of power to, or adjusting one or more parameters associated with industrial equipment; causing removal or reduction of power to the industrial equipment depending on the location of the intruder; adjusting one or more parameters associated with industrial equipment or another source of danger depending on the location of the intruder; logging the breach event and its location in at least one database; further processing the captured images to determine whether the intruder has a mandated type of personal protective equipment (PPE) required for the boundary involved in the boundary event; further processing the captured images to determine whether the intruder has authorization required for causing the boundary event; deterring an intruder, using the location of the intruder, that exhibits a type of undesired behavior and/or is carrying or wearing undesired equipment; selecting protection devices based on the location of the intruder and controlling the protection devices; and determining and providing visual markers to mark an exit route to exit a vicinity of a danger event detected in the captured images.

9. The computer-implemented method of claim 8, wherein processing the captured images includes using facial recognition to determine an identity of the intruder, and determining whether the boundary event is allowed includes determining authorization of the identified intruder to approach or cross the boundary involved in the boundary event.

10. The computer-implemented method of claim 1, wherein the visual markers are geometric shapes or images projected by a projector of a laser or other lights.

11. The computer-implemented method of claim 1, wherein determining the boundaries includes determining dynamically a configuration of the one or more boundaries, wherein the visual markers are projected based on the dynamically determined configuration.

12. The computer-implemented method of claim 1, wherein processing the captured images and/or processing captured audio includes monitoring the captured images and/or the captured audio for a danger event, and the method further comprises revising the one or more boundaries based on detection of the danger event.

13. The computer-implemented method of claim 11, wherein revising the boundaries includes determining an exit route to exit a vicinity of the danger event and providing visual markers to mark the exit route.

14. The computer-implemented method of claim 1, further comprising capturing the images.

15. The computer-implemented method of claim 1, further comprising projecting the visual markers.

16. A system for management of one or more danger zones for industrial equipment, the system comprising:
a memory configured to store a plurality of programmable instructions; and
at least one processing device disposed in communication with the memory, wherein the at least one processor upon execution of the program instructions is configured to:
determine a configuration of one or more boundaries associated with the one or more danger zones in the vicinity of the industrial equipment;
cause projection of visual markers on surfaces, the visual markers being configured based on the configuration of the respective one or more boundaries;
process images captured of the visual markers to detect a boundary event related to the visual markers, the boundary event including the presence of an intruder that is a person or an object proximate to, crossing over, moving to, or moving from the one or more visual markers;
determine whether the boundary event is allowed;
process data from the visual monitoring to determine a location of the intruder before, during, or after the boundary event;
select, contingent on a determination that the boundary event is not allowed, one or more automated actions based on the location of the intruder; and
cause performance of the one or more automated actions.

17. The system of claim 16, wherein processing the captured images includes determining, using a machine learning trained model that was trained to recognize different types of PPE worn by a person in motion, whether the intruder is wearing a type of PPE required for the boundary involved in the boundary event, and the determination whether the boundary event is allowed is based on the determination whether the intruder is wearing the type of PPE, wherein the one or more automated actions are further selected based on whether the intruder is wearing a type of PPE required for the boundary involved in the boundary event.

18. The system of claim 16, wherein processing the captured images to detect the boundary event includes applying vision detection, comprising:
detecting the visual markers and the intruder in the captured images; and
comparing locations in the image of the detected visual markers and the detected intruder.

19. The system of claim 16, wherein the one or more boundaries include a plurality of boundaries, the respective boundaries having different associated restrictions, and the actions are further selected based on which of the one or more boundaries was involved in the boundary event.

20. The system of claim 16, wherein the location of the intruder is tracked and the one or more automated actions include at least one of: providing a visual and/or audible warning based on the tracked location of the intruder; providing a directional visual and/or audible warning directed to the intruder at the tracked location of the intruder; providing via a networked device associated with the intruder or the industrial equipment a warning about the boundary event; causing removal of or reduction of power to, or adjusting one or more parameters associated with industrial equipment; logging the breach event and its location in at least one database; further processing the captured images to determine whether the intruder has a mandated type of personal protective equipment (PPE) required for the boundary involved in the boundary event; further processing the captured images to determine whether the intruder has authorization required for causing the boundary event; selecting protection devices based on the location of the intruder and controlling the protection devices; and determining and providing visual markers to mark an exit route to exit a vicinity of a danger event detected in the captured images.

21. A method for management of one or more danger zones for industrial equipment, wherein the method comprises:
processing captured images and/or captured audio at least to recognize a dangerous event using one or more trained machine learning models;
predicting locations of the dangerous event based on the processed captured images and/or audio using the one or more trained machine learning models;
causing projection of visual markers on surfaces and configured based on the predicted locations; and
causing output of directional video and/or audio aid as an exit guide to a safe zone.
